(19) United States
(12) Patent Application Publication
(10) Pub. No.: US 2008/0222902 A1
(43) Pub. Date: Sep. 18, 2008

(54) Device for storing a shaving razor or other implement with an associated container

(76) Inventor: William S. Bisceglia, Rye, NY (US)

Correspondence Address: LAW OFFICE OF LEO ZUCKER, 2591 Duning Drive, PO BOX 1177, Yorktown Heights, NY, 10598, US

(21) Appl. No.: 12/154,325

(22) Filed: May 22, 2008

Related U.S. Application Data
(63) Continuation-in-part of application No. 11/409,370, filed on Apr. 22, 2006.
(60) Provisional application No. 60/674,421, filed on Apr. 25, 2005.

(51) Int. Cl. B26B 21/40

(52) U.S. Cl. 30/541

(57) ABSTRACT

A device for storing an implement such as a razor next to an associated container. An endless band of elastomeric material is formed to be stretched and released about the container. A mouth portion formed of the same material is disposed on the periphery of the band for retaining the implement. The mouth portion has a pair of arms spaced apart enough to receive the implement, and a pair of gates each of which is joined at a first end to an outer end of a corresponding arm. Each gate is biased toward a rest position where a second end of the gate opposite its first end confronts the second end of the other gate. The gates deflect inward when the implement is urged horizontally into the mouth portion, and return to their rest position when the implement clears them so that the implement is then stored in the device.

### CROSS REFERENCE TO RELATED APPLICATIONS

The present application is a continuation-in-part of my co-pending U.S. patent application Ser. No. 11/409,370 filed Apr. 22, 2006. The '370 application claims priority under 35 U.S.C. § 119(e) of my U.S. Provisional Patent Application No. 60/674,421 filed Apr. 25, 2005.

### BACKGROUND OF THE INVENTION

1. Field of the Invention

This invention concerns devices for holding or storing shaving razors and other implements while such implements are not in use.

2. Discussion of the Known Art

U.S. Pat. No. 5,544,783 (Aug. 13, 1996) discloses a straw tube holder for aerosol spray cans. The holder is in the form of a flexible C-clip that clamps about the circumference of an associated can. A pair of C-shaped brackets are formed on the circumference of the clip, and the brackets are dimensioned to grip hollow spray tubes or “straws” that are used to apply the contents of the can. U.S. Pat. No. 5,992,678 (Nov. 30, 1999) also discloses straw tube holder for spray cans. The patented holder includes an elastic band having a grip surface for arrangement around the periphery of the can, and a loop that protrudes from the band for retaining a straw or other elongated item against the grip surface of the band.

U.S. Pat. No. 5,806,669 (Sep. 15, 1998) discloses a razor support structure which in one embodiment includes a large clip portion that partially encircles a can of shaving cream, and a small clip portion fixed to the large clip portion. The small clip portion has a pair of outwardly extended end portions for grasping the handle of a razor. U.S. Pat. No. 4,695,029 (Sep. 22, 1987) also describes a device for securing a razor on a can of shaving cream. The device of the '029 patent includes a plastics collar that can snap on and off an upper portion of the can, and a flange that extends outward from the collar. An opening formed in the flange receives the handle of the razor, and the blade head of the razor rests on the flange.

U.S. Pat. No. 6,869,053 (Mar. 22, 2005) shows a holder including a suction cup for attachment to a wall, and a ring through which a razor or a toothbrush can be inserted. See also, U.S. Pat. Nos. 4,320,832 (Mar. 23, 1982), and No. 4,656,738 (Apr. 14, 1987); and U.S. Design Patents D-409,087 (May 4, 1999), and D-315,306 (Mar. 12, 1991).

U.S. Pat. No. 6,328,459 (Dec. 11, 2001) discloses a releasable holder for decorative lights or other generally cylindrical objects. Portions of the holder form two arcuate C-shaped openings, and the diameter of each portion is slightly smaller than the diameter of a light socket to be held in the portion. The holder including the arcuate portions are preferably molded from polycarbonate, according to the patent.

There remains a need for a device that can be easily affixed onto cans of various sizes containing, for example, shaving cream, and which (i) enables a corresponding implement (e.g., a shaving razor) to engage the device safely for storage while the can and the razor are not in use, and (ii) allows the razor to disengage safely from the device for use. It is also desirable that the device be suited for large scale production at a relatively low cost.

There also exists a need for a storing device that can accommodate different types and shapes of shaving razors, and that is user friendly with respect to ease of attachment onto an associated container.

### SUMMARY OF THE INVENTION

According to the invention, a device for storing an implement together with a container whose contents require use of the implement, includes an endless band of elastomeric material dimensioned to adhere on an outside circumference of the container after the band is stretched and released about the container, and a mouth portion formed of the elastomeric material is disposed on the periphery of the band for engaging the implement. The mouth portion includes a pair of arms that extend radially from the band and are spaced apart an amount sufficient to receive part of the implement when the part is inserted between the arms, and a pair of gates each of which is joined at a first end to an outer end of a corresponding arm so that each gate is biased toward a first, rest position at which a second end of the gate opposite its first end confronts the second end of the other gate. The gates are formed to deflect to a second position between the arms when urged by the part of the implement, and to return to the first position once the implement clears the second ends of the gates, so that the implement is stored in the device in proximity to the container.

For a better understanding of the invention, reference is made to the following description taken in conjunction with the accompanying drawing and the appended claims.

### BRIEF DESCRIPTION OF THE DRAWING

In the drawing:

FIG. 1 is a perspective view showing the inventive storing device as fitted on a can of shaving cream;

FIG. 2 is a view similar to FIG. 1, showing a safety razor engaged by the inventive device for storage adjacent the can;

FIG. 3 is a top view of the fitted storing device in FIG. 1; and

FIG. 4 is a side elevation view of the fitted storing device in FIG. 1.

### DETAILED DESCRIPTION OF THE INVENTION

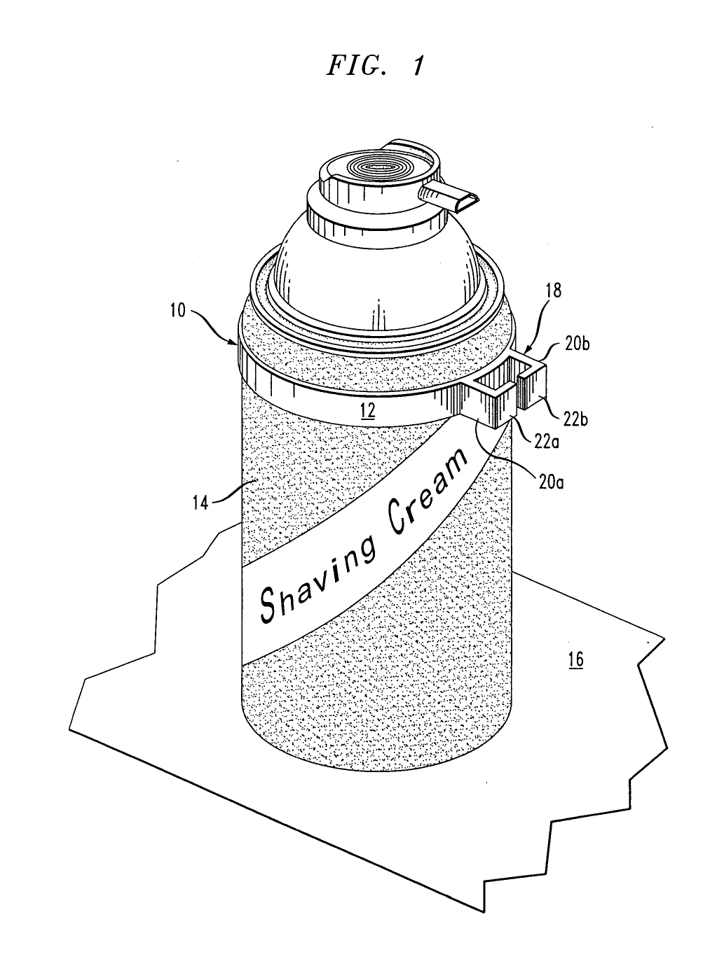

FIG. 1 shows a storing device 10 according to the invention. Although the device 10 is illustrated as fitted on a pressurized can 14 of shaving cream, it will be understood that the device 10 may be used on containers of other products in order to retain or store an implement that is needed in order to use such products.

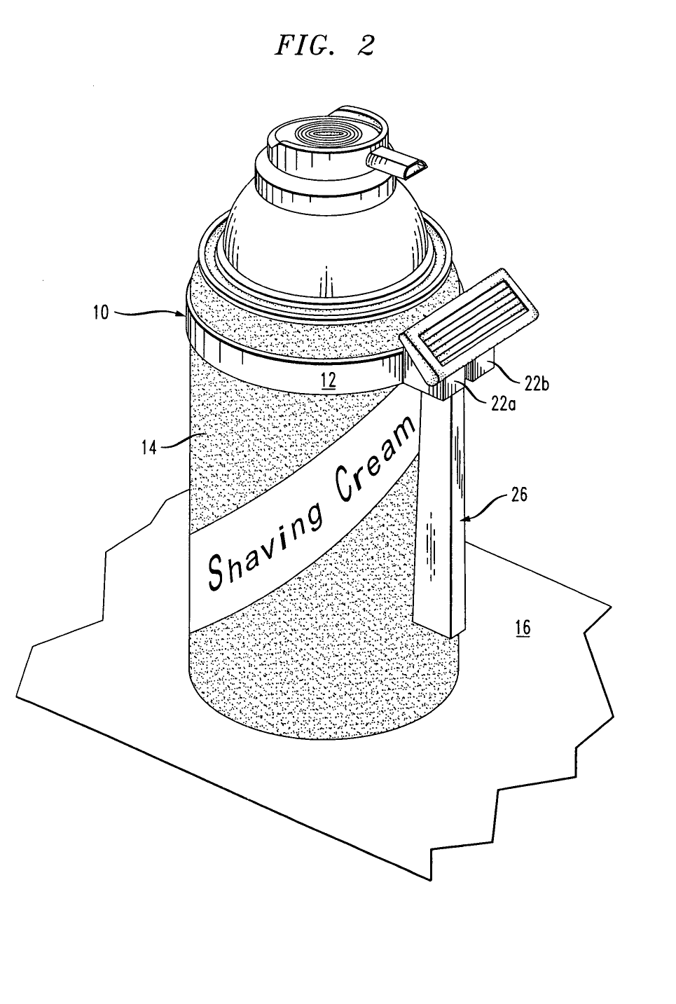

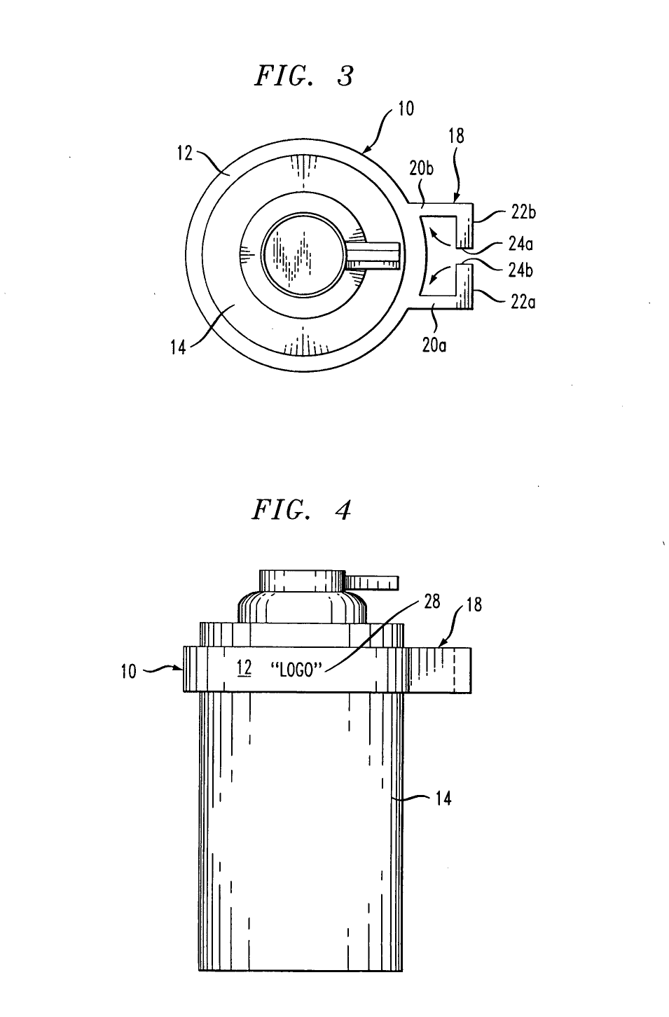

As seen in FIGS. 1 and 3, the device 10 includes an endless, closed elastomeric band 12 that is dimensioned to surround and adhere on the outside circumference of the can 14 by friction, after the band 12 is stretched and released about the can 14 at a desired height. Preferably, the band 12 is placed at a sufficient height on the can 14 so that a bottom end of an implement stored by the device 10 is kept clear of a rest surface 16 on which the can 14 rests, once the implement is retained by the device 10. See, e.g., the safety razor 26 in FIG. 2.

The device 10 also has a mouth portion 18. The mouth portion 18 is fixed on the outer periphery of the band 12, and is formed with a pair of side walls or arms 20a, 20b that project radially outward from the band. The arms 20a, 20b are spaced apart by an amount sufficient to receive a part of the implement to be stored (e.g., the upper neck of the razor 26 in FIG. 2) when the implement is inserted between the arms 20a, 20b. The mouth portion 18 also includes a pair of flaps or gates 22a, 22b each of which is joined at a first end to a radially outer end of a corresponding arm 20a, 20b.

The storing device 10 may be formed of an elastomeric material such as, for example, silicone rubber, styrene butadiene rubber (SBR), nitrile rubber (NBR), or ethylene propylene diene rubber (EPDM). The gates 22a, 22b of the mouth portion 18 are therefore biased by the material of the device toward a first, rest position at which a second end 24a, 24b (see FIG. 3) of each gate opposite its first end, closely confronts or abuts the second end 24b, 24a of the other gate. Thus, the band 12, the arms 20a, 20b and the gates 22a, 22b together form a substantially closed rectangular space in a horizontal plane when the gates are at the rest position, as seen in FIG. 3.

The arms 20a, 20b and the gates 22a, 22b of the mouth portion 18 are also formed so that, when urged by a part (e.g., a handle) of the implement, the gates deflect resiliently in the direction of the arrows in FIG. 3 to a second position within the rectangular space between the arms; and then return to the first position in FIG. 3 once the implement clears the deflected second ends of the gates. The implement, e.g., the safety razor 26 in FIG. 2, is then retained at a storage position next to the can 14.

If the cross section of the retained part of the implement is wider than the rest spacing between the arms 20a, 20b, the arms will retain the implement by friction at the storage position. If the cross-section of the implement does not exceed the bounds of the rectangular space between the arms 20a, 20b, the implement may slide vertically downward through the space until a widened top part of the implement rests on the arms 20a, 20b. See, for example, the razor head in FIG. 2.

As shown FIG. 4, various indicia 28 may be displayed using, e.g., a silk screen printing process, embossing, or debossing on the outer or inner periphery of the band 12. For example, a brand name of shaving cream contained in the can 10, or the user's or another company's name. Pigments or dyes may be added to the material of the device 10 so as to produce the device in one or more attractive colors. As mentioned, although a pressurized can of shaving cream is illustrated in the disclosed embodiment, it will be understood that the device 10 may be used with various types of cans, plastics bottles, or containers whose contents require the use of an applicator or other implement capable of being stored in the mouth portion 18 of the device.

To use the device 10, the band 12 is stretched over the can 14 and released at a position near the top rim of the can. If the can has a nozzle as provided on a can of shaving cream, the nozzle should be rotated to a 12:00 position, while the mouth portion 18 of the device is placed at 9:00 if the user is right-handed or at 3:00 if the user is left-handed. The neck of the razor (or other implement) is pushed through the gates 22a, 22b of the mouth portion, so as to engage the razor with the device 10 for storage. The can should not be shaken while the razor is engaged with the device 10, unless the handle of the razor is urged by the user's thumb safely against the side of the can.

The razor neck may then be pulled horizontally out of the gates 22a, 22b to disengage the razor from the device 10 when the razor is to be used. When the can is empty, the device 10 may be removed and cleaned with mild soap and warm water. For safety, any razor blade guard supplied with the razor should continue to be used while the razor is stored in the device 10. The guard may be placed, e.g., on top of the mouth portion 18 while the user is shaving.

### EXAMPLE ONE

Silicone rubber having a durometer of 50 was injection molded and cured at 425 degrees F. to form a storing device 10 having the following dimensions:

| Inside diameter of band 12: | 2⅜ | inches. |
|---|---|---|
| Outside diameter of band 12: | 2½ | inches. |
| Thicknesses of band 12 and gates | 1/16 | inch. |
| 22a, 22b: | | |
| Thickness of band 12 between arms | ⅛ | inch. |
| 20a, 20b: | | |
| Widths of band 12, gates 22a, 22b | ½ | inch. |
| and arms 20a, 20b: | | |
| Thickness of arms 20a, 20b: | ⅛ | inch. |
| Inside clear dimensions of mouth | ½″ between arms × 7/16″ | |
| opening 18: | between band and gates. | |
| Gap between confronting (second) ends | 1/16 | inch. |
| of gates 22a, 22b: | | |

The band 12 of the device of Example One can be stretched by hand and released onto cans having an outer diameter of 2.5 inches or a diameter up to 20 percent greater, i.e., up to 3.0 inches, and the device 10 then used to retain an associated implement (e.g., a shaving razor) in proximity to the can.

### EXAMPLE TWO

Silicone rubber having a durometer of 50 was injection molded and cured at 425 degrees F. to form a storing device 10 having the following dimensions:

| Inside diameter of band 12: | 1⅞ | inches. |
|---|---|---|
| Outside diameter of band 12: | 2 | inches. |
| Thicknesses of band 12 and gates | 1/16 | inch. |
| 22a, 22b: | | |
| Thickness of band 12 between arms | ⅛ | inch. |
| 20a, 20b: | | |
| Widths of band 12, gates 22a, 22b | ½ | inch. |
| and arms 20a, 20b: | | |
| Thickness of arms 20a, 20b: | ⅛ | inch. |
| Inside clear dimensions of mouth | ½″ between arms × 7/16″ | |
| opening 18: | between band and gates. | |
| Gap between confronting (second) ends | 1/16 | inch. |
| of gates 22a, 22b: | | |

The band 12 of the device of Example Two can be stretched by hand and released onto cans having an outer diameter of 2.0 inches or a diameter up to 20 percent greater, i.e., up to 2.4 inches, and the device 10 then used to retain an associated implement (e.g., a shaving razor) in proximity to the can.

As disclosed herein, the device 10 can be easily and firmly retained on cans having a wide range of diameters, and an associated implement such as a safety razor may be stored safely in the device when the can and the implement are not in use. Especially for razors, it is not necessary for a user to grasp the razor head directly. Instead, the user need only grasp the razor handle to insert or withdraw the neck of the handle horizontally into or out of the mouth portion 18.

The inventive device 10 is distinguishable from prior holders that are molded from polycarbonate or other rigid plastics materials, both in its construction and in the safety and other desirable features it offers. For example, once the safety razor clip of U.S. Pat. No. 4,320,832 is snapped about the base of a container, as taught in the patent, the user must urge a bottom end of their razor handle into the clip opening from the vertical direction, i.e., downward along the axis of the clip opening. Thus, the user must grasp the razor at or near the razor head while taking care not to cut their hand as they urge the handle downward into the opening. With the inventive device 10, however, the razor handle may be inserted horizontally into the mouth portion of the device while the user's hand is kept a safe distance from the head of the razor.

Also, because of the materials from which they are made, prior holders such as the razor clip of the mentioned '832 patent or the releasable holder of U.S. Pat. No. 6,328,459, are limited to gripping items whose cross sections are only slightly larger than the openings formed in the holders. By contrast, the mouth portion 18 of the inventive device can retain razors whose handles have cross sections that are either greater, or smaller, than that of the mouth portion. Further, the band 12 can be used to secure the device on containers having a range of diameters that vary by as much as 20 percent.

Silicone rubber has been discovered to be a material from which the device 10 is preferably molded. As such, the device is user friendly in that it is attached to a container simply by stretching, rather than having to bend, and possibly snap, a rigid plastics from which prior holders are made. The material can be mixed with color dyes so that the device can be produced in a variety of attractive colors, and it can retain print or other inked indicia on its surface without smearing. Natural rubber may also be used, but additional steps may be needed to avoid smearing of any surface print. Moreover, the device 10 can be easily packaged such as by coiling or rolling to occupy minimal space.

While the foregoing represents preferred embodiments of the invention, it will be understood by those skilled in the art that various modifications may be made without departing from the spirit and scope of the invention, and that the invention includes all such modifications as are within the scope of the following claims.

I claim:

1. A device for storing an implement together with a container whose contents require use of the implement, comprising:
an endless band of elastomeric material dimensioned to adhere on an outside circumference of the container after the band is stretched and released about said circumference;
a mouth portion formed of said elastomeric material disposed on the outer periphery of the band for engaging the implement, wherein the mouth portion includes,
a pair of arms that extend radially from the band and are spaced apart by an amount sufficient to receive a part of the implement when said part is inserted between the arms; and
a pair of gates each of which is joined at a first end to a radially outer end of a corresponding arm so that each gate is biased toward a first, rest position at which a second end of the gate opposite its first end confronts or abuts the second end of the other gate;
wherein the gates are formed to deflect to a second position between the arms when urged by a part of the implement and to return to the first position once the implement clears the second ends of the gates, so that the implement is retained in the mouth portion of the device at a storage position in proximity to the container.

2. A device according to claim 1, wherein the elastomeric material comprises silicone rubber.

3. A device according to claim 2, wherein the silicone rubber has a durometer of approximately 50.

4. A device according to claim 1, wherein the elastomeric material includes a color dye.

5. A device according to claim 1, wherein the band has indicia displayed on either an outer or an inner periphery of the band.

6. The device of claim 5, wherein the indicia comprises a brand name.

7. The device of claim 6, wherein the brand name is associated with a shaving cream.

8. A device according to claim 1, wherein the arms and the gates of the mouth portion are dimensioned and arranged for retaining part of a handle of a razor in the storage position in proximity to the container.

9. A device according to claim 1, wherein the band has an inside diameter of about 2⅜ inches when the band is unstretched.

10. A device according to claim 1, wherein the band has an inside diameter of about 1⅞ inches when the band is unstretched.

11. A device according to claim 1, wherein the band is formed to be stretched and released about the circumference of containers having diameters that vary over a range of 20 percent.

12. A system for storing a razor in proximity to a container of shaving cream, the razor having an elongated handle with a neck portion, comprising:
an endless band of elastomeric material dimensioned to adhere on an outside circumference of the container after the band is stretched and released about said circumference;
a mouth portion formed of said elastomeric material disposed on the outer periphery of the band for engaging the neck portion of the razor handle, wherein the mouth portion includes,
a pair of arms that extend radially from the band and are spaced apart by an amount sufficient to receive the neck portion of the razor handle when the neck portion is inserted between the arms; and
a pair of gates each of which is joined at a first end to a radially outer end of a corresponding arm so that each gate is biased toward a first, rest position at which a second end of the gate opposite its first end confronts or abuts the second end of the other gate;
wherein the gates are formed to deflect to a second position between the arms when urged by the neck portion of the razor handle and to return to the first position once the neck portion clears the second ends of the gates, so that the razor is stored in the mouth portion of the device in proximity to the container of shaving cream.

13. A system according to claim 12, wherein the elastomeric material comprises silicone rubber.

14. A system according to claim 13, wherein the silicone rubber has a durometer of approximately 50.

15. A system according to claim 12, wherein the elastomeric material includes a color dye.

16. A system according to claim 12, wherein the band has indicia associated a brand name of a shaving cream displayed on an outer or inner periphery of the band.

17. A system according to claim 12, wherein the band has an inside diameter of about 2⅜ inches when the band is unstretched.

18. A system according to claim 12, wherein the band has an inside diameter of about 1⅞ inches when the band is unstretched.

19. A system according to claim 12, wherein the band is formed to be stretched and released about the circumference of shaving cream containers having diameters that vary over a range of 20 percent.
